(19) United States
(12) Patent Application Publication
(10) Pub. No.: US 2013/0179906 A1
(43) Pub. Date: Jul. 11, 2013

(54) INFORMATION EXCHANGING METHOD FOR MULTIPLE OPERATION SYSTEMS IN AN ELECTRONIC DEVICE

(71) Applicant: ASUSTEK COMPUTER INC., Taipei (TW)

(72) Inventors: Po-Wei CHOU, Taipei (TW); Chin-Yuan TENG, Taipei (TW); Wen-Shiu HSU, Taipei (TW)

(73) Assignee: ASUSTEK COMPUTER INC., Taipei (TW)

(21) Appl. No.: 13/725,527

(22) Filed: Dec. 21, 2012

(30) Foreign Application Priority Data
Jan. 9, 2012 (TW) 101100783

(51) Int. Cl. G06F 9/54

(52) U.S. Cl. CPC G06F 9/541
USPC 719/319

(57) ABSTRACT

A method for exchanging information between multiple operation systems in an electronic device is provided. The electronic device is installed with a first and a second operation system. The method includes steps of: storing a shared information is stored in a storage unit under the first operation system; transmitting an exchange command to an information exchanging unit in order to log off the first operation system; logging in the second operation system; and (iv) judging a status of the information exchanging unit and retrieving the shared information from the storage unit in order to allow the second operation system to read or execute the shared information.

This application claims the benefits of the Taiwan Patent Application Serial NO. 101100783 filed on Jan. 9, 2012, the subject matter of which is incorporated herein by reference.

### BACKGROUND OF THE INVENTION

1. Field of the Invention

The present invention relates to an information exchanging method, more particularly to a method for exchanging information between multiple operation systems in an electronic device.

2. Description of the Prior Art

Due to rapid advance in the electronic technology, some electronic devices become indispensible handy electronic devices for a majority of the consumers. These handy electronic devices include for instance a PC (personal computer) and a mobile phone.

In general, an electronic device presently available is usually installed with, more than two operation systems in order to read different pieces of information or data or execute different types of commands and application. Due to development of specific operation system for execution some particular types of information or data or application, the presently existing operation systems are unable to execute those particular types of information or application.

Under such circumstances, a piece of information, a command or an application to be executed under a first operation system, the execution cannot be executed smoothly under second operation system in case said piece of information, said command or said application is not compatible with the second operation system. If the person concerned still wants the abovementioned piece of information, command or application to be executed, he or she must reboot the electronic device again and needs manually select or installed an operation system that is compatible with the abovementioned piece of information, command or application. Then only, the execution of the desired piece of information or command can be executed smoothly under newly installed operation system, hence causing inconvenience and discomfort to the user of the electronic device.

Presently, there are more and more types of application or information available in the market, which lead the unskilled users of the electronic device to a situation to judge, which application is compatible with what type of operation system. When the display screen of the electronic device pop up a warning window during the application is executing, the user is put suddenly in a state how to continue with the work he is working on while the other users will helplessly read the contents in the warning window and do as instructed by the contents, i.e., reboot the electronic device again and manually select or installed an operation system that is compatible with the presently employed application.

As stated above, the presently technique is unable to solve the aforesaid problem, where the operation system is not compatible with the application, the user of the must reboot the electronic device again and needs manually select or installed a new operation system. Then only, the execution of the desired applications can be executed smoothly under newly installed operation system, hence causing inconvenience and discomfort to the user.

### SUMMARY OF THE INVENTION

Therefore, the main object of the present invention is to provide a method for exchanging information between multiple operation systems in an electronic device. The information exchanging operation includes reading specific information, execution an application or a particular order or command.

The method of the present invention is used in an electronic device for exchanging information between multiple operation systems in the electronic device. The electronic device is installed with at least first and second operation systems. The information exchange method of the present invention includes steps of: storing a shared information in a storage unit under the first operation system; transmitting an exchange command to an information exchanging unit in order to log off the first operation system; logging in the second operation system; and (iv) judging a status of the information exchanging unit and retrieving the shared information from the storage unit in order to allow the electronic device operates under the second operation system.

After transmission of the exchange command to the information exchanging unit, the first operation system is logged off. Transmission of the exchange command to the information exchanging unit causes adjustment in the flag of the exchange command.

During the step (iv), upon reading adjustment of the flag of the exchange command, the shared information is retrieved from the storage unit, and the second operation system execute the exchange command.

In one embodiment of the present invention, the information exchanging unit is a firmware or a basic output and input system. Preferably, the shared information consists of an execution command, an indicator signal or an application.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 shows a block diagram illustrating elements required for information exchanging method of the present invention for an electronic device;

FIG. 2 shows a block diagram illustrating steps in the information exchanging method of the present invention between multiple operation systems in the electronic device; and

FIG. 3 shows a block diagram illustrating other steps in the information exchanging method of the present invention between multiple operation systems in the electronic device.

### DETAILED DESCRIPTION OF THE PREFERRED EMBODIMENT

A method of the present invention is widely used in several types of electronic devices for exchanging information between multiple operation systems. When an electronic device is installed with more than two operation systems, information exchanging (such as file sharing, application) between the two operation systems can be conducted once the method of the present invention is implemented.

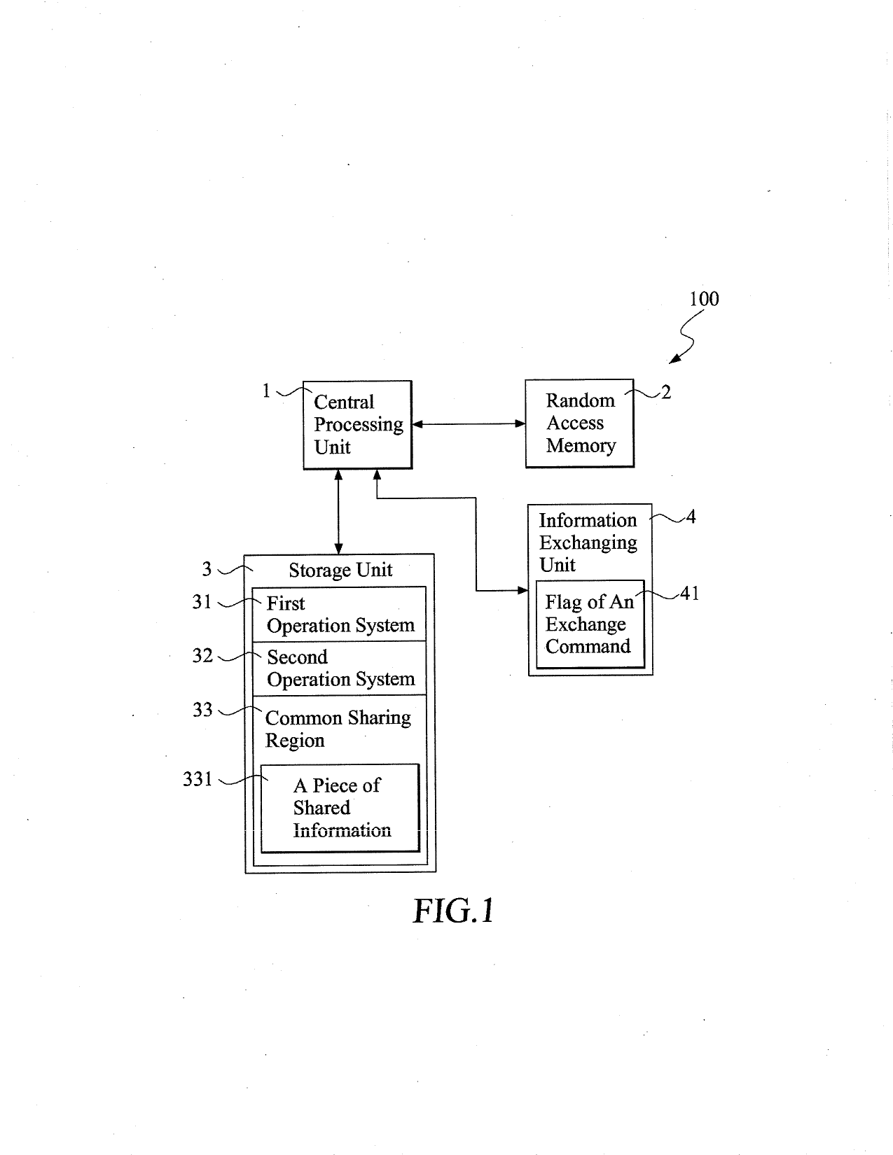

FIG. 1 shows a block diagram illustrating elements required for information exchanging method of the present invention for an electronic device. As illustrated, the electronic device 100 is maintained to conduct the abovementioned information exchanging operation between two operation systems, includes a CPU (central processing unit) 1, a RAM (Random Access Memory) 2, a storage unit 3 and an information exchanging unit 4. The CPU 1 is connected electrically to the RAM 2, the storage unit 3 and the information exchanging unit 4.

Note that programs for executing a task under the first and second operation systems 31, 32 are stored in the storage unit 3, which has a common sharing region 33.

The information exchanging unit 4 is configured to possess an exchange command 41 with a specific flag. The abovementioned electronic device 100 is a computer set, a mobile phone or any other electronic device installed with more than two operation systems. The storage unit 3 is a hard disk or a solid state drive while the information exchanging unit 4 is a BOIS (basic output and input system) or a firmware.

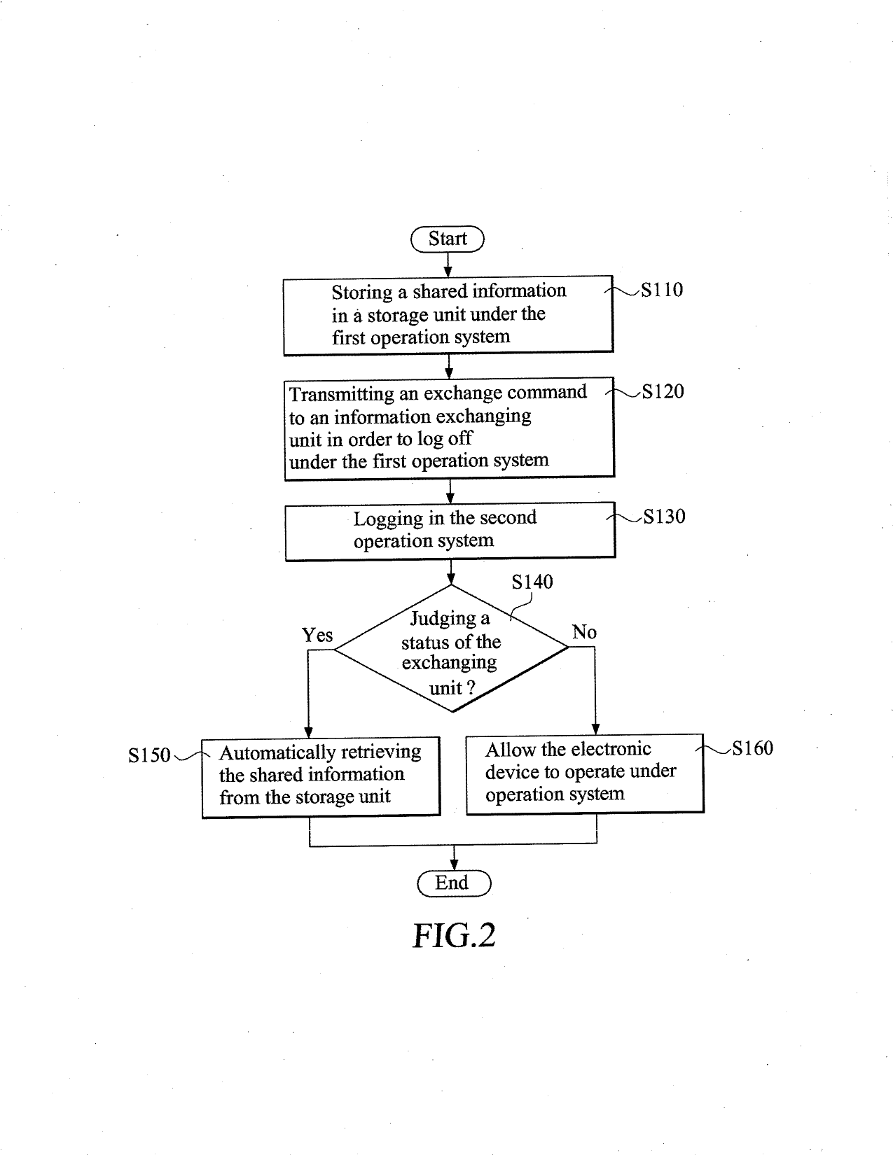

FIG. 2 shows a block diagram illustrating steps in the information exchanging method of the present invention between multiple operation systems in the electronic device. As illustrated, also referring to FIG. 1, prior to exchanging information between the first and second operation systems, in the event that the computer set is working under the first operation system and is required to share or exchange information or application with the second operation system. At this time, the shared information 331 or the application needs to be stored in the common sharing region 33 of the storage unit 3 under the first operation system so that operation of the computer under the first operation system is logged off. After that the second operation system is logged in, and the shared information 331 is retrieved from the common sharing region 33 of the storage unit 3 under the second operation system in order to allow the electronic device to operate under the second operation system. In one embodiment, the shared information 331 consists of an execution command, an indicator signal or an application (Step 110).

During the user booting up of the electronic device 100 so as to log in the first operation system, the CPU 1 and the RAM 2 simultaneously operate under the first operation system. In the event, the user wishes to retrieve the shared information 331 and if the shared information 331 is not compatible with the first operation system (i.e., the electronic device operates poorly under the first operation system), the electronic device 100 will automatically store the shared information 331 in the common sharing region 33 of the storage unit 3 and the first operation system will simultaneously transmits an exchange command to the information exchanging unit 4 in order to log off the first operation system, wherein the flag 41 of the information exchanging unit 4 is changed from “0” to “1”.

At this time, the operation of the electronic device 100 is logged off such that the first operation system is switched into a suspended mode (step 120).

In accordance with the step (130), the second operation system of the electronic device 100 is automatically logged in, meanwhile judges the status (the flag 41) of the information exchanging unit 4 and decides whether to conduct the information exchange operation (step 140).

In this embodiment, upon reading adjustment of the flag of the exchange command 41 being “1” means that the shared information only can be exchanged under the second operation system. At this time, the CPU 1 will under the second operation system retrieve the shared information 331 automatically from the common sharing region 33 of the storage unit 3 (step 150). In the present step 150, if the shared information 331 consists of an execution command, an indicator signal or an application, the second operation system execute a specific task.

During conducting of the above step and if there is no exchange command generated, it means that no information exchange operation is required or that the information exchange operation is finished such that the flag of the exchange command 41 retrieves to “0” from “1”.

As far as the second operation system is concerned, during logging in the second operation system and upon reading adjustment of the flag of the exchange command 41 being “0” means that there is no exchange command. At this time, the CPU 1 and the RAM 2 of the electronic device operate under the second operation system and does not execute the shard information (step 160).

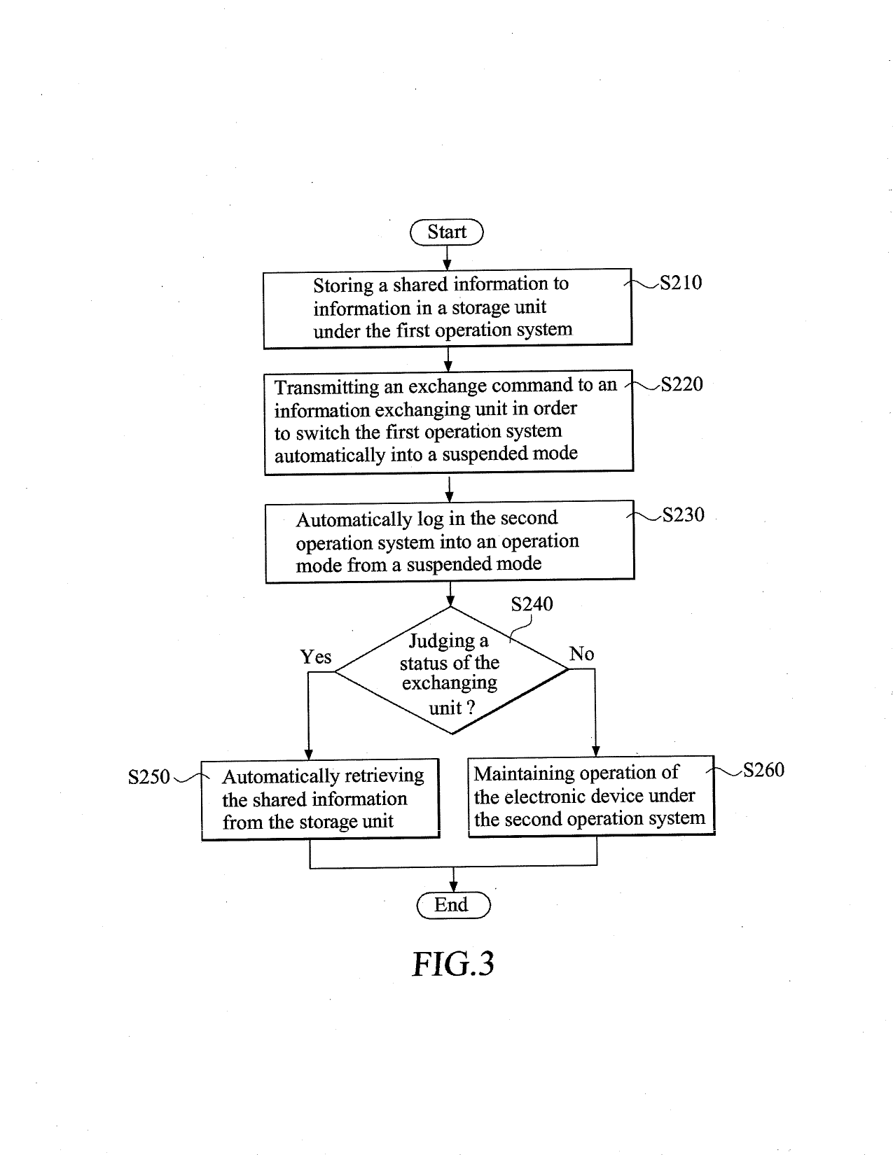

FIG. 3 shows a block diagram illustrating other steps in the information exchanging method of the present invention between multiple operation systems in the electronic device. In one embodiment, the information exchange operation is conducted when the first operation system of the electronic device 100 is switched into a suspended mode meanwhile the second operation system is logged in and switched into an operation mode from a suspended mode.

Referring to FIGS. 1 and 3, prior to conducting the information exchange operation, the shared information 331 is stored in the common sharing region 33 of the storage unit 3. The shared information 331 may consist of an execution command, an indicator signal or an application (Step 210).

During the user booting up of the electronic device 100 so as to separately log in the first operation system 31 and the second operation system 32, the none required one of the first and second operation systems 31, 32 will be switched into the suspended mode in accordance with the pre-set application of the shared information.

In one embodiment, the information exchanging unit 4 and the shard information 331 are configured in such a manner to be operated under the first operation system. Hence, after booting up the electronic device, the CPU 1 and the RAM 2 can operate under the first operation system.

While under the first operation system, in the event the user wishes to retrieve the shared information 331 and finds that the shared information 331 is not compatible the first operation system (i.e., the electronic device operates poorly under the first operation system). At this time, the first operation system will transmit the exchange command 41 to the information exchanging unit 4, where the flag of exchange command 41 is changed from “0” to “1” means that the conduction of information exchange can be executed only under another operation system. At this time, the operation of the electronic device 100 under the first operation system is logged off, i.e., the first operation system is logged off and switched into the suspended mode (step 220).

In accordance with the step (230), the second operation system of the electronic device 100 is automatically logged in (i.e., is switched into the operation mode from the suspended mode), meanwhile judges the status (the flag) of the exchange command 41 and decides whether to conduct the information exchange operation (step 240).

Upon reading the flag of the exchange command 41 being “1” means that the conduction of information exchange can be executed. At this time, the CPU 1 will under the second operation system retrieve the shared information 331 automatically from the common sharing region 33 of the storage unit 3 (step 250). In the present step 250, if the shared information 331 consists of an execution command, an indicator signal or an application, the second operation system execute the specific task.

During conducting of the above step and if there is no exchange command generated, it means that no information exchange operation is required or that the information exchange operation is finished such that the flag of the exchange command 41 retrieves to “0” from “1”. As far as the second operation system is concerned, during logging in the second operation system and upon reading adjustment of the flag of the exchange command 41 being “0” means that there is no exchange command. At this time, the CPU 1 and the RAM 2 of the electronic device operate under the second operation system and does not execute the shard information (step 260).

As described above, in the above embodiment, the first and second operation systems are loaded in advance so as to switch the first operation system into the operation mode while the second operation system thereof is switched into the suspended mode. Note that the electronic device working under the first operation system is interrupted means the first operation system is switched into the suspended mode. Logging in the second operation system means that the second operation system will automatically switch into the operation mode from the suspended mode.

Another feature of the information exchange of the present invention is that one requires to log in the first operation system only. When the first operation system is logged off, it means to switch the first operation system into the suspended mode, i.e., suspending the operation of the first operation system. Logging in the second operation system means the second operation system is switched into the operation mode meanwhile suspending the first operation system.

For those skilled persons in the art, in the prior art technique, upon encountering an application, information or a command that are not compatible with the presently employed operation system, the user of the electronic device must reboot the electronic device again and needs manually select or installed an operation system that is compatible the abovementioned shared information, command or application. Then only, the execution of the abovementioned shared information or command can be executed smoothly under newly installed operation system. In the present invention, by utilizing and altering the flag of the exchange command in the information exchanging unit, in case of encountering the application or the information is not compatible with the presently employed operation system, another operation system compatible with the designated application will be automatically logged in so as to perform the execution, hence causing convenience and comfort to the user of the electronic device installed with the information exchange method of the present invention.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for exchanging information between multiple operation systems in an electronic device, the electronic device being installed with a first operation system and a second operation system, the method comprising step of:
storing a shared information in a storage unit under the first operation system;
transmitting an exchange command to an information exchanging unit in order to log off the first operation system;
logging in the second operation system; and
judging a status of said information exchanging unit and retrieving said shared information from said storage unit in order to allow the second operation system to execute said shared information.

2. The method according to claim 1, wherein after transmitting an exchange command to an information exchanging unit the step, the first operation system is switched into a suspended mode.

3. The method according to claim 1, wherein after transmitting an exchange command to an information exchanging unit, the first operation system is logged off automatically.

4. The method according to claim 1, wherein after logging in the second operation system, the second operation system is switched into an operation mode from a suspended mode.

5. The method according to claim 1, wherein after logging in the second operation system, the first operation is logged off while the second operation system is automatically logged in.

6. The method according to claim 1, wherein said information exchanging unit is a firmware or a basic output and input system.

7. The method according to claim 1, wherein said storage unit is a hard disk or a solid state drive.

8. The method according to claim 1, wherein during transmitting an exchange command to an information exchanging unit, the flag status is automatically adjusted according to the exchange command.

9. The method according to claim 8, wherein during judging said status of said information exchanging unit and retrieving said shared information from said storage unit, and upon reading adjustment of said flag of said exchange command, the second operation system retrieves said shared information automatically from said storage unit.

10. The method according to claim 1, wherein said shared information consists of an execution command, an indicator signal or an application.

11. The method according to claim 1, wherein during logging in the second operation system, in case the first operation system is unable to read or execute said shared information, the first operation system automatically generates said exchange command.
